(19) United States
(12) Patent Application Publication
(10) Pub. No.: US 2005/0002171 A1
(43) Pub. Date: Jan. 6, 2005

(54) Light housing for instrument cluster

(75) Inventors: Christian Jean Tanguy, Sterling Heights, MI (US); Werner Eckardt, Rochester, MI (US); Vyacheslav B. Birman, Rochester Hills, MI (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation

(21) Appl. No.: 10/732,793

(22) Filed: Dec. 10, 2003

Related U.S. Application Data
(60) Provisional application No. 60/484,466, filed on Jul. 2, 2003.

(51) Int. Cl. G01D 11/28

(52) U.S. Cl. 362/23

(57) ABSTRACT

A vehicle instrument cluster 10 includes a dial or display 16 having a graphical image that is illuminated by a light source. The light source is mounted to a printed circuit board (PCB). A light housing is used to support the dial relative to the PCB. The light housing includes an inclined reflective surface that is located directly above the light source. The light housing also includes at least one radially extending channel used to more evenly illuminate a desired portion of the graphical image. The channel includes a flat portion that is mounted directly to the PCB. An intermediate portion extends from the flat portion and is spaced apart from the PCB to define a gap. The instrument cluster control electronics are mounted to the PCB within this gap. A beveled portion extends from the intermediate portion upwardly toward the dial. The inclined reflective surface, channel, intermediate portion, and beveled portion cooperate to provide multiple reflective surfaces for evenly and brightly illuminating the graphical image.

### CROSS-REFERENCE TO RELATED APPLICATIONS

The application claims priority to U.S. Provisional Application No. 60/484,466, which was filed on Jul. 2, 2003.

### BACKGROUND OF THE INVENTION

This invention relates to a vehicle instrument cluster that utilizes a light source and light housing with multiple reflective surfaces to illuminate a graphical display on a dial.

An instrument cluster for a vehicle is traditionally located on a vehicle dashboard and includes several gauges or dials that indicate various vehicle operating conditions. For example, an instrument cluster may include a speedometer, a tachometer, an engine condition indicator, and other known types of gauges. These gauges are illuminated to facilitate reading of the information by the vehicle occupants.

Instrument clusters include a printed circuit board (PCB) with electronic components for controlling operation of the instrument clusters. Light sources are typically mounted to the PCB. A light box or light housing is used to contain the light produced by the light sources inside the instrument cluster and prevents unwanted light leakage. The light housing is also used to distribute the light from the light source over the graphical area to be illuminated. The instrument cluster further includes display or dial on which the graphical image is formed or mounted.

Improvements in the area of optics over the years has resulted in a significant increase in light output from light sources. This has significantly reduced the number of light sources needed to adequately illuminate a graphical display. However, this increased light output has also made it more difficult to evenly distribute luminance over the display.

One solution to this problem has been to use a light guide or pointer. The light guide is formed as a piece of clear material that channels the light and redistributes the light evenly over the display. One disadvantage with using a light guide is system cost. The additional light guide component increases research, material, assembly, and tooling costs.

Another solution for providing even illumination requires the use of compensation. Compensation is achieved by darkening the bright spots to the level of the “darkest” spot. This requires the application of a layer of absorbing material to the display gauge or dial. This solution has one main disadvantage. The light efficiency is poor because a large quantity of light produced by the light source is absorbed by the compensation layer.

Another solution to produce a more cost effective instrument cluster is to minimize the amount of space on the PCB that is taken up by non-electronic components. Additional electronic components can be mounted to the PCB when the non-electrically productive or “keep out” area is reduced. The “keep out” area is an area on the PCB where placement of the electronic components is not possible because mechanical components, such as the light housing, cover, etc., are in contact with the PCB. There is often a trade-off between minimizing the “keep out” area and securely mounting the light housing to the display to provide an illuminated graphical display.

Thus, there is a need for an instrument cluster that provides a more even and bright graphical illumination with a reduced number of light sources in addition to minimizing the “keep out” area of the PCB.

### SUMMARY OF THE INVENTION

A vehicle instrument cluster includes a dial or display having at least one graphical image and at least one light source for illuminating the graphical image. A light housing cooperates with the light source to direct the light toward the graphical image and more evenly distribute the light over the graphical image. The light housing includes an inclined reflective surface, which extends directly over the light source, and at least one channel that receives the light reflected from the inclined reflective surface and directs this reflected light toward the graphical image.

In one disclosed embodiment, the light source is mounted directly to a printed circuit board (PCB) positioned underneath the dial. The light housing supports the dial relative to the PCB. The light housing includes a vertically extending support wall that engages a portion of the dial and the PCB. A roof portion extends from the support wall over the light source. The inclined reflective surface is formed on a surface of the roof portion that faces the light source. The channel includes a flat base portion that is mounted directly to the PCB adjacent the light source, i.e. there is at most a very small, non-functional, space between the PCB and the base portion. The light from the light source is reflected off of the inclined reflective surface toward the base portion of the channel. The channel reflects the light onto the desired area of the graphical image.

In one disclosed embodiment, the light housing also includes an intermediate portion that extends from the flat base portion. The intermediate portion is vertically higher relative to the PCB than the flat base portion, i.e. the intermediate portion is spaced apart from the PCB to define a gap. Control electronics for the instrument display are mounted on the PCB underneath the intermediate portion within this gap.

A beveled portion of the light housing extends from the intermediate portion towards the dial. A support flange then extends from the beveled portion toward the outer circumference of the dial. The outer circumferential portion of the dial rests on this support flange. The inclined reflective surface, channel, intermediate portion, and beveled portion cooperate to provide multiple reflective surfaces for illuminating the graphical image.

The subject system and method for illuminating a graphical image with a light source utilizes a unique light housing that more evenly and brightly illuminates the desired area of the graphical image. These and other features of the present invention can be best understood from the following specifications and drawings, the following of which is a brief description.

### BRIEF DESCRIPTION OF THE DRAWINGS

FIG. 1 a schematic view of a back illumination instrument panel incorporating the subject invention.

FIG. 2A is an overhead view of a light source and light housing configuration incorporating the subject invention.

FIG. 2B is a reverse configuration of the embodiment shown in FIG. 2A.

FIG. 3A is a cross-sectional view taken of the light housing of FIGS. 2A and 2B.

FIG. 3B is a cross-sectional view of a channel formed in the light housing of FIGS. 2A and 2B.

FIG. 4 is a schematic view of a light path for the embodiment shown in FIG. 3.

FIG. 5 is an alternate embodiment of a display incorporating the subject invention.

FIG. 6 is an alternate embodiment of a display incorporating the subject invention.

### DETAILED DESCRIPTION OF A PREFERRED EMBODIMENT

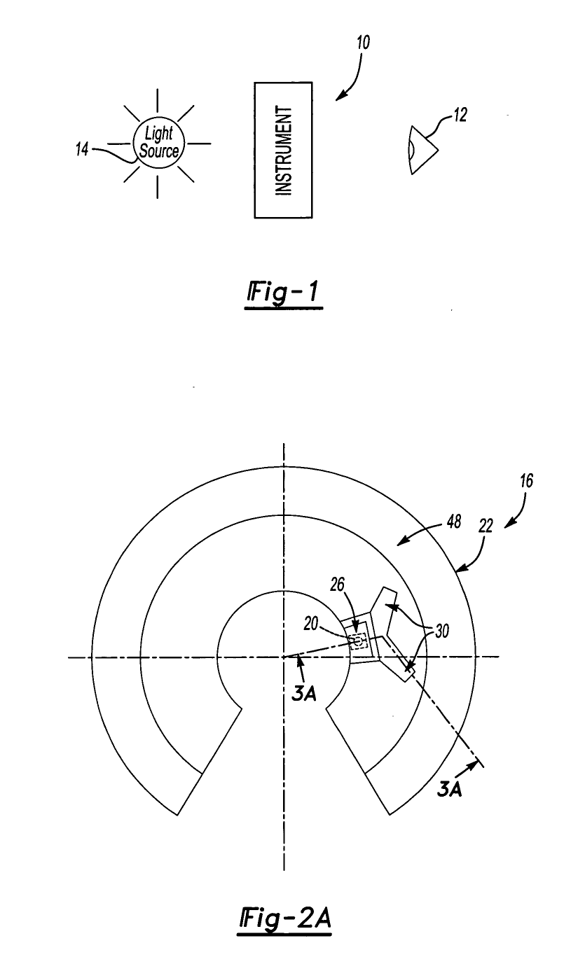

An instrument cluster is shown generally at 10 in FIG. 1. The instrument cluster 10 is illuminated to facilitate reading of vehicle operating information by a vehicle occupant 12. The instrument cluster 10 can be front illuminated or back illuminated. The subject invention is especially useful in a back illuminated configuration where a light source 14 is placed behind the instrument cluster 10 such that light passes through the instrument cluster 10 before reaching the vehicle occupant 12.

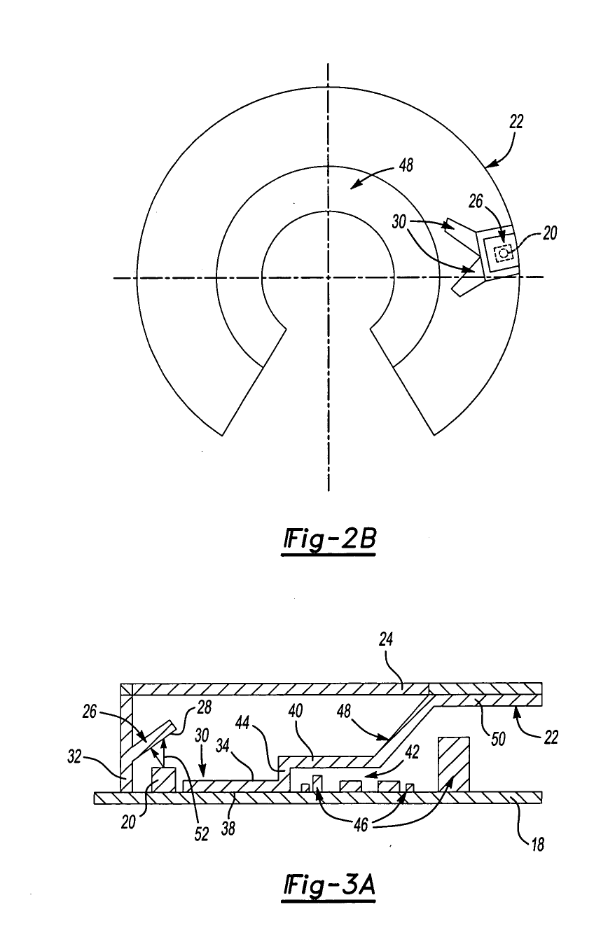

As shown in FIGS. 2A and 2B, the instrument cluster 10 includes at least one gauge, dial assembly, or display 16 that displays vehicle operating information. The dial assembly or display 16 can comprise a liquid crystal display (LCD), circular dial member with painted graphics, or any other type of display known in the art. This dial assembly 16 could be a speedometer, a tachometer, an engine condition indicator, or any other type of gauge or dial known in the art. The dial assembly 16 includes a printed circuit board (PCB) 18, at least one light source 20 supported on the PCB 18, and a light housing 22 for reflecting light toward a graphical image formed or mounted on a dial or display component 24. The light source 20 is preferably an LED, however, any other type of light source known in the art could also be used.

The light housing 22 includes a roof portion 26 that defines an inclined reflective surface 28 (see FIG. 3A) that extends directly over the light source 20. The roof portion 26 can extend radially outwardly from an inner circumference of the light housing 22, as shown in FIG. 2A, or can extend radially inwardly from an outer circumference of the light housing 22, as shown in FIG. 2B. In either configuration, the light housing 22 also includes at least one channel 30 (two (2) channels 30 are shown in FIGS. 2A and 2B) that is used to more evenly distribute light over a desired area of the graphical image on the dial 24.

The light housing 22 and PCB 18 are shown in greater detail in FIGS. 3A and 3B. The light housing 22 is supported on the PCB 18 and in turn is used to support the dial 24. The light housing 22 includes a first vertically extending wall 32 that extends from the PCB 18 to the dial 24 to form a support wall. The roof portion 26 extends outwardly from this vertical wall 32 at an angle. The inclined reflective surface 28 is formed on the bottom surface of the roof portion 26 that directly faces the light source 20. The light source 20 is mounted to the PCB 18 and is positioned directly underneath the inclined reflective surface 28.

The channel 30 includes a base portion 34 that is positioned adjacent to the light source 20 at one end and extends generally radially away from the light source 20 to a distal end. The channel 30 is preferably U-shaped in cross-section, however, the size and shape of the channel 30 could change depending on the particular application in which the instrument cluster 10 is being used.

As shown in FIG. 3B, the U-shaped channel includes the base portion 34 and a pair of side walls 36 that extend upwardly from the base portion 34 to form the U-shape. The light from the light source 20 is reflected off of the inclined reflective surface 28 toward the walls 36 and base portion 34 of the channel 30. The size and shape of the inclined reflective surface 28 can vary depending on the particular application. The use of a channel configuration provides multiple reflective surfaces to more evenly distribute the light onto the graphical display.

The base portion 34 includes a bottom surface 38 that is mounted directly to the PCB 18, as shown in FIG. 3A, i.e. there is a very small no gap between the PCB 18 and channel 30 along a predetermined length of the channel 30. The base portion 34 transitions into an intermediate portion 40 that is spaced apart from the PCB 18 to define a gap 42. A transitional wall 44 connects the base portion 34 to the intermediate portion 40. The transitional wall can be a vertical wall, or can extend at an angle relative to the base portion 34. Electronic components 46 that are used to control operational characteristics of the instrument cluster 10 are mounted to the PCB 18 underneath the intermediate portion 40 within the gap 42.

The intermediate portion 40 transitions into a beveled surface 48 that preferably extends away from the intermediate portion 40 at an angle. The beveled surface 48 transitions into a support flange 50 that directly engages the dial 24. The support flange 50 provides additional support for the dial 24 at the outer circumference of the dial 24, and further seals or contains light emitted from the light source 20 within the light housing 22. Thus, the inclined reflective surface 28, channels 30, intermediate portion 40, and beveled surface 48 cooperate to provide a plurality of reflective surfaces inside the light housing 22. These reflective surfaces produce multiple reflections inside the light housing 22 before the light gets through the dial 24 and reaches the view of the vehicle occupant 12.

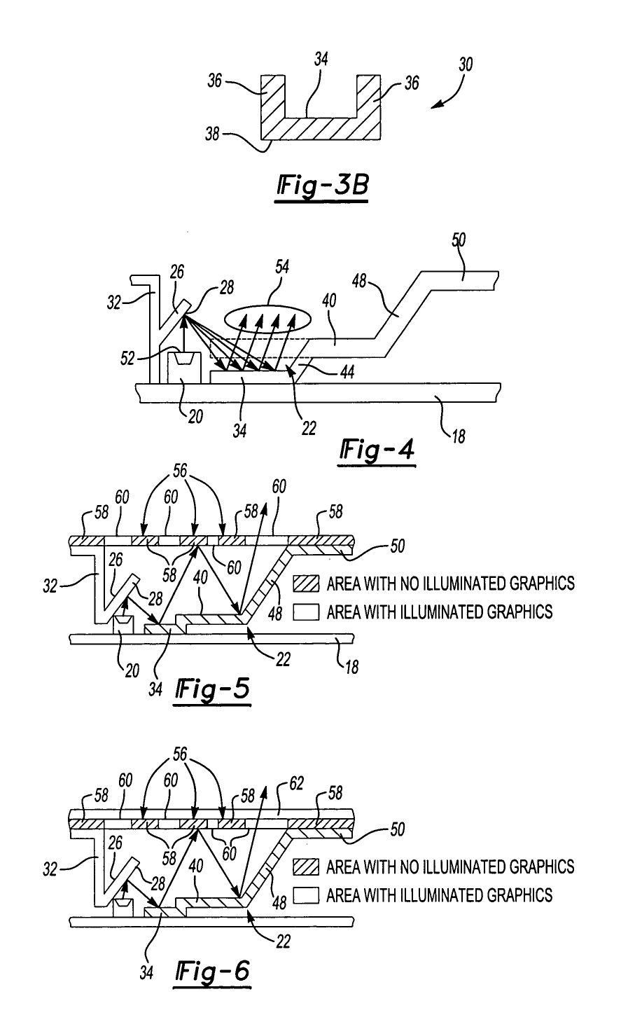

Preferably, the base portion 34 is positioned closer to the PCB 18 than the emission point 52 from which light is emitted from the light source 20. This allows more light to be reflected from the channel 22 than would occur if the base portion 34 were located at a vertically higher position (see dashed lines of FIG. 4). Thus, light is reflected off of the inclined reflective surface 28 towards the channel 22, which in turn reflects the light upwardly toward the dial 24 as indicated by arrows 54.

In one disclosed embodiment, shown in FIG. 5, the dial 24 includes a reflective white layer 56 that is applied to areas 58 on the dial 24 where there are no illuminated graphics. The reflective white layer 56 is preferably an opaque layer while the areas 58 with no illuminated graphics are preferably translucent. This combination improves the light efficiency. The light is reflected off of the channel 22 toward these areas 58, which in turn reflect the light back towards the channel 22. The light is eventually reflected to an area 60 on the dial 24 that provides illuminated graphics.

In one disclosed embodiment, shown in FIG. 6, a layer of anisotropic film 62 is applied to the dial 24. Preferably, Vikuiti™ XRVS film produced by 3M Corporation is used. This film is typically used in high definition projection televisions. The film 62 is preferably applied to an upper surface of the dial 24 and covers areas 60 that provide illuminated graphics as well as areas 58 where there are no illuminated graphics. The film 62 is preferably applied to a dial surface that is opposite from the surface where the reflective white layer 56 is applied.

The film 62, as used in a television application, includes a first surface having half spherical shapes and a second surface that is generally flat and shiny. When the film 62 is used in an instrument cluster 10 application, the light path is reversed from the traditional path used for television applications. The shiny flat surface faces away from the vehicle occupant 12 with the spherical surface facing the occupant 12. This configuration generates a small well-defined viewing angle. The film 62 does not absorb the light; the light is redirected through the film 62 to provide the well-defined viewing angle. Another advantage with this film 62 is that ambient light (sun light) does not reflect on this film so the instrument cluster 10 does not have to be placed deep within the instrument panel. This increases available packaging space for other instrument panel components.

Although a preferred embodiment of this invention has been disclosed, a worker of ordinary skill in this art would recognize that certain modifications would come within the scope of this invention. For that reason, the following claims should be studied to determine the true scope and content of this invention.

1. An instrument cluster comprising:
a display including at least one graphical image;
at least one light source positioned to illuminate at least a portion of said graphical image;
a circuit board including a plurality of electronic components for controlling operational characteristics of an instrument cluster wherein said light source is supported on said circuit board; and
at least one light housing supported by said circuit board and including a first wall portion with an inclined extension extending over said light source wherein said inclined extension includes a reflective surface facing said light source for directing light to illuminate said graphical image.

2. The cluster of claim 1 wherein said light housing includes at least one channel having a generally flat base portion defining a reflective surface.

3. The cluster of claim 2 wherein said channel is defined by a U-shaped cross-section including a pair of sides extending upwardly from said base portion.

4. The cluster of claim 2 wherein a bottom surface of said base portion directly engages said circuit board adjacent to said light source.

5. The cluster of claim 4 wherein said light housing includes an intermediate portion and a second wall portion transitioning from said base portion of said channel to said intermediate portion wherein said intermediate portion is positioned vertically higher relative to said circuit board than said base portion to define a gap between said light housing and said circuit board.

6. The cluster of claim 5 wherein said electronic components are mounted to said circuit board directly underneath said intermediate portion within said gap.

7. The cluster of claim 5 wherein said light housing includes a beveled surface extending from said intermediate portion toward said display, said beveled surface cooperating with said inclined extension, said channel, and said intermediate portion to provide a plurality of reflect surfaces to evenly illuminate said graphical image.

8. The cluster of claim 2 wherein said at least one channel comprises a plurality of channels each defining a reflective surface to evenly illuminate a desired area of said graphical image.

9. The cluster of claim 1 wherein said display includes a white reflective layer applied to display areas that do not have illuminated graphics.

10. The cluster of claim 9 wherein said display includes a layer of anisotropic film applied to a surface opposite from said white reflective layer.

11. A method for illuminating an instrument cluster comprising the steps of:
supporting a light housing on a circuit board;
supporting a display including at least one graphical image with the light housing;
mounting a light source on the circuit board to illuminate at least a portion of the graphical image;
extending a reflective portion of the light housing over the light source; and
reflecting light generated by the light source with the reflective portion to illuminate the graphical image.

12. The method of claim 11 including the steps of forming at least one channel having a generally flat base portion in the light housing and reflecting light from the reflective portion toward the base portion.

13. The method of claim 12 further including the steps of forming the channel with a U-shaped cross-section with a pair of sides extending upwardly from the base portion, and mounting a bottom surface of the base portion directly to the circuit board.

14. The method of claim 12 further including the steps of forming the light housing with an intermediate portion extending upwardly from the base portion, spacing the intermediate portion apart from the circuit board to define a gap, and mounting cluster control electronic components to the circuit board underneath the intermediate portion within the gap.

15. The method of claim 14 further including the steps of forming the light housing with a beveled portion extending from the intermediate portion toward the display and using the reflective portion, channel, intermediate portion, and beveled portion to provide multiple reflective surfaces for illuminating the graphical image.

16. The method of claim 1 1 including the step of applying a reflective while layer to areas on the display that do not have illuminated graphics.

17. The method of claim 16 including the step of applying a layer of anisotropic film to the display.
